(19) United States
(12) Patent Application Publication
(10) Pub. No.: US 2005/0182987 A1
(43) Pub. Date: Aug. 18, 2005

(54) Battery state monitoring circuit and battery device

(76) Inventor: Atsushi Sakurai, Chiba-shi (JP)

Correspondence Address: Bruce L. Adams, Esq., 31st Floor, 50 Broadway, New York, NY, 10004, US

(21) Appl. No.: 11/058,946

(22) Filed: Feb. 16, 2005

(30) Foreign Application Priority Data
Feb. 16, 2004 (JP) 2004-038275

(51) Int. Cl. G06F 1/28

(52) U.S. Cl. 713/340

(57) ABSTRACT

Provided is an easy-to-use battery device capable of instantly driving an external load immediately after assembly in a factory. The battery device is constructed to be prevented from entering a power-down state in which discharging is inhibited at the time of turning on the power. Therefore, the generation of a discharge inhibiting signal and the shift to the power-down state are prevented during a predetermined transient period after the time of turning on the power.

### BACKGROUND OF THE INVENTION

1. Field of the Invention

The present invention relates to a battery state monitoring circuit capable of controlling the charge and discharge of a secondary battery and a battery device including the battery state monitoring circuit.

2. Description of the Related Art

A power source device as shown in a circuit block diagram of FIG. 2 has been known as a conventional battery device composed of a secondary battery. A secondary battery 201 is connected with external terminals 204 and 205 through a switch circuit 203 serving as a current limiting section. The external terminals 204 and 205 can be connected with a charger or an external load. A battery state monitoring circuit 202 is connected in parallel with the secondary battery 201. The battery state monitoring circuit 202 has a function for detecting the voltage and current of the secondary battery 201.

When the secondary battery 201 is in any one of: an over-charge state in which a voltage thereof is higher than a predetermined voltage value; an over-discharge state in which the voltage is lower than the predetermined voltage value; and an over-current state in which a current larger than a predetermined current flows into the switch circuit 203 and the external terminal 205 reaches a given voltage, a charge/discharge inhibiting signal is outputted from the battery state monitoring circuit 202 to the switch circuit 203. Therefore, the switch circuit 203 can be turned OFF to stop a charge current or a discharge current. In a state other than over-charge state, the over-discharge state, and the over-current state, the secondary battery 201 becomes a normal state in which it is chargeable and dischargeable.

When the external load is connected between the external terminals 204 and 205, discharging progresses and the secondary battery 201 becomes the over-discharge state in which the voltage is lower than the predetermined voltage value. Then, when the discharge inhibiting signal is outputted from the battery state monitoring circuit 202, the switch circuit 203 is turned OFF to stop the discharge current. Therefore, a power source voltage supplied from the secondary battery 201 to the external terminal 205 is cut off, so the external terminal 205 is pulled up by the external load and becomes a potential of the external terminal 204. Simultaneously, even in the battery state monitoring circuit 202, the external terminal 205 is pulled up to a potential of a positive terminal of the secondary battery 201, that is, a potential of the external terminal 204 through a predetermined impedance.

The battery state monitoring circuit 202 detects that the external terminal 205 is pulled up to increase a voltage, so current consumption thereof is reduced. This is referred to as a power-down state. The power-down state is provided to minimize the amount of discharge of the secondary battery 201. The power-down state for reducing the current consumption of the battery state monitoring circuit 202 maintains until a charger is connected between the external terminals 204 and 205 to start charging and a reduction in voltage of the external terminal 205 is detected (for example, see JP 04-075430 A “chargeable power source device”).

However, with respect to a conventional battery device, there is a problem in that an initial state when it is assembled in the factory becomes the power-down state. For example, when the secondary battery having a normal state voltage in an assembly process is connected with the battery state monitoring circuit, the secondary battery transiently becomes the over-discharge state while a power source voltage of the battery state monitoring circuit is increased from 0 V to the normal state voltage. Therefore, the battery state monitoring circuit determines that the secondary battery is in the over-discharge state during this transient period and outputs the discharge inhibiting signal. In this time, if the external load is connected between the external terminals 204 and 205, the external terminal 205 is pulled up to increase a voltage. Thus, in some cases, the battery state monitoring circuit detects the increased voltage and enters the power-down state.

The conventional battery device that enters the power-down state in assembly is in a discharge inhibiting state even when it is connected with the secondary battery having the normal state voltage. Therefore, there is a problem in that the external load cannot be instantly driven. In addition, when the external load is driven, it is necessary to perform charging once such that a voltage of the external terminal 205 is reduced to release the power-down state.

### SUMMARY OF THE INVENTION

Therefore, the present invention has been made to solve the conventional problems. An object of the present invention is to provide an easy-to-use battery device capable of instantly driving an external load immediately after assembly.

In order to solve the above-mentioned problems, according to the present invention, a battery state monitoring circuit has a structure in which the circuit is prevented from entering a power-down state in which discharging is inhibited at the time of turning on the power. More specifically, the generation of a discharge inhibiting signal and the shift to the power-down state are prevented during a predetermined transient period after the time of turning on the power.

According to the battery state monitoring circuit and the battery device in the present invention, the generation of the discharge inhibiting signal and the shift to the power-down state in which discharging is inhibited at the time of turning on the power are prevented. Therefore, the problems related to the conventional battery device that enters the power-down state in assembly are solved, so an external load can be instantly driven immediately after assembly. Thus, when the battery device starts to be used, it is unnecessary to perform charging once to release the power-down state, with the result that the easy-to-use battery device can be provided.

### BRIEF DESCRIPTION OF THE DRAWINGS

In the accompanying drawings:

FIG. 1 is a circuit block diagram showing a battery state monitoring circuit and a battery device according to Embodiment 1 of the present invention;

FIG. 2 is a circuit block diagram showing a conventional battery state monitoring circuit and a conventional battery device;

FIG. 3 is a circuit block diagram showing a battery state monitoring circuit and a battery device according to Embodiment 2 of the present invention;

FIG. 4 is a circuit block diagram showing a power-down protection circuit in Embodiment 1 of the present invention; and

FIG. 5 is a block diagram showing a part of a logic circuit in Embodiment 1 of the present invention.

### DETAILED DESCRIPTION OF THE PREFERRED EMBODIMENTS

### Embodiment 1

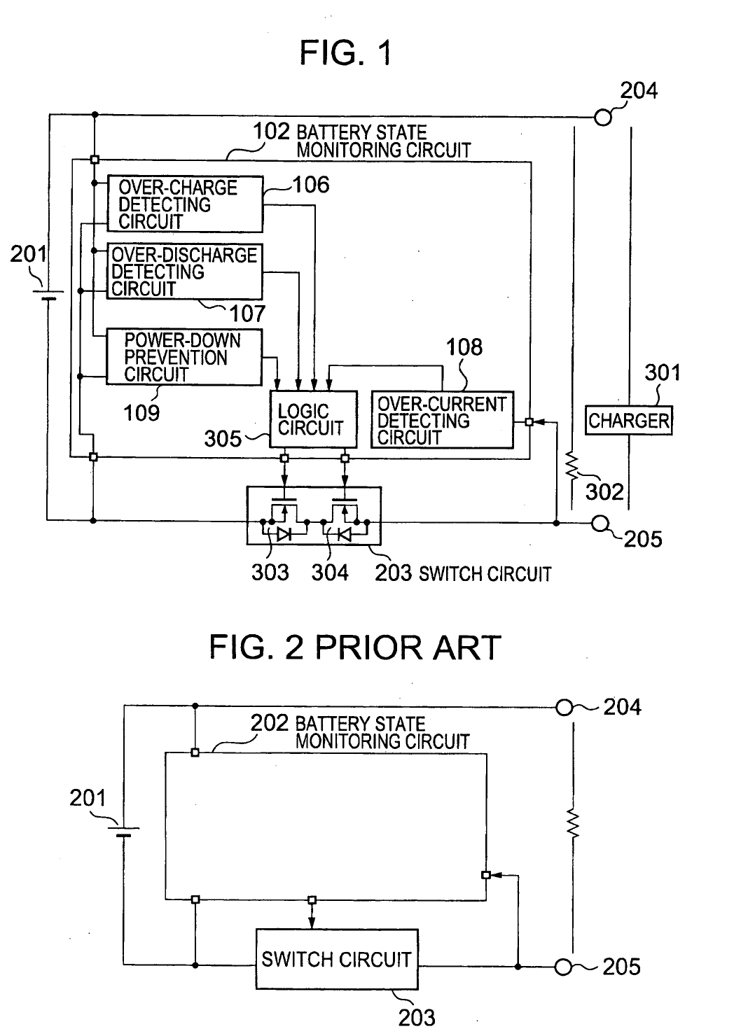

FIG. 1 is a circuit block diagram showing a battery state monitoring circuit and a battery device according to Embodiment 1 of the present invention. In FIG. 1, a battery state monitoring circuit 102 is composed of an over-charge detection circuit 106, an over-discharge detection circuit 107, an over-current detection circuit 108, a power-down protection circuit 109, and a logic circuit 305.

The battery state monitoring circuit 102 operates using a secondary battery 201 as a power source. When a voltage of the secondary battery 201 is equal to or smaller than an upper limit of a chargeable voltage and equal to or larger than a lower limit of a dischargeable voltage and a discharge current flowing into a switch circuit 203 is equal to or lower than a predetermined value, the logic circuit 305 of the battery state monitoring circuit 102 outputs a Hi signal to each of a FET-A 303 and a FET-B 304 to turn on the FET-A 303 and the FET-B 304. Such a state is referred to as a normal state.

When a charger 301 is connected between external terminals 204 and 205, the battery state monitoring circuit 102 starts to be charged. When the voltage of the secondary battery 201 exceeds the upper limit of the chargeable voltage, a detection signal is outputted from the over-charge detection circuit 106. The logic circuit 305 outputs a Lo signal to the FET-B 304 to turn off the FET-B 304. Such a state is referred to as an over-charge state.

When a load 302 is connected between external terminals 204 and 205, the battery state monitoring circuit 102 starts to discharge. When the voltage of the secondary battery 201 becomes smaller than the lower limit of the dischargeable voltage, a detection signal is outputted from the over-discharge detection circuit 107. The logic circuit 305 outputs a Lo signal (hereinafter referred to as a discharge inhibiting signal) to the FET-A 303 in the switch circuit 203 to turn off the FET-A 303. Such a state is referred to as an over-discharge state.

In the over-discharge state, the switch circuit 203 is turned OFF to cut off the discharge current. Therefore, the supply of a power source voltage from the secondary battery 201 to the external terminal 205 is stopped, so the external terminal 205 is pulled up by the external load and becomes a potential of the external terminal 204. Simultaneously, even in the battery state monitoring circuit 102, the external terminal 205 is pulled up to a potential of a positive terminal of the secondary battery 201, that is, the potential of the external terminal 204 through a predetermined impedance. The battery state monitoring circuit 102 detects that the external terminal 205 is pulled up to increase a voltage, so current consumption thereof is reduced. This is referred to as the power-down state.

The power-down state is provided to minimize the amount of discharge of the secondary battery 201. The power-down state for reducing the current consumption of the battery state monitoring circuit 102 maintains until the charger is connected between the external terminals 204 and 205 to start charging and a reduction in voltage of the external terminal 205 is detected.

When the load 302 is connected between the external terminals 204 and 205 to start discharging and the discharge current flowing into the switch circuit 203 having a predetermined ON resistance increases so that the potential of the external terminal 205 becomes equal to or larger than the predetermined value (that is, the discharge current flowing into the switch circuit 203 becomes equal to or larger than the upper limit value), a detection signal is outputted from the over-current detection circuit 108 of the battery state monitoring circuit 102. The logic circuit 305 outputs the discharge inhibiting signal to the FET-A 303 to turn off the FET-A 303.

The logic circuit 305 provides a necessary delay time to the detection signal and a release signal with respect to the over-charge detection circuit 106, the over-discharge detection circuit 107, and the over-current detection circuit 108, so erroneous operation caused by temporal noise can be prevented. With respect to the over-charge detection circuit 106, the over-discharge detection circuit 107, and the over-current detection circuit 108, a necessary hysteretic voltage is provided between a detection signal and a release voltage, so erroneous operation caused at the time of detection or release can be prevented.

The power-down protection circuit 109 monitors the power source voltage of the battery state monitoring circuit 102. The power-down protection circuit 109 outputs a detection signal only for a predetermined time when it detects a transient increase in voltage which is caused at the time of turning on the power. In this time, the logic circuit 305 is disabled from outputting the discharge inhibiting signal only for the predetermined time. The power-down protection circuit 109 is a circuit shown in FIG. 4, for example.

In FIG. 4, the power-down protection circuit 109 is composed of a capacitor 401, a constant current circuit 402, and an inverter 403. When the secondary battery 201 is connected with the power-down protection circuit 109, a voltage inputted to the inverter 403 is reduced according to a time constant determined by the capacitor 401 and the constant current circuit 402. The output of the inverter 403 is held to a Lo level only for a predetermined time period from the connection of the secondary battery 201. The predetermined time can be freely set in the power-down protection circuit 109. Various circuit structures can be used for the power-down protection circuit 109.

FIG. 5 is a block diagram showing a part of the logic circuit 305. FIG. 5 shows a PMOS-FET 501 and a latch circuit 502. When the latch circuit 502 is in the normal state, a reset signal 503 is a Lo level, a set signal 504 is a Lo level, and an output signal 505 is a Lo level. When the latch circuit 502 is in the over-discharge state, the reset signal 503 is a Lo level, the set signal 504 is a Hi level, and the output signal 505 is a Hi level. In the case where a noise component of a Hi level is superposed on the set signal 504 in the latch circuit 502, even when the secondary battery 201 has a normal state voltage, the latch circuit 502 is set, so the output signal 505 becomes the Hi level. Therefore, the over-discharge state is erroneously determined. The noise is likely to cause at the instant when the secondary battery 201 is connected with the battery state monitoring circuit 102 at the time of turning on the power.

Therefore, in order to prevent such erroneous determination in the present invention, the drain of the PMOS-FET 501 is connected with a reset terminal of the latch circuit 502 and an output signal from the power-down protection circuit 109 is inputted to the gate of the PMOS-FET 501. That is, because the output of the power-down protection circuit 109 is held to the Lo level only for the predetermined time period from the connection of the secondary battery 201, the PMOS-FET 501 is being turned ON for the predetermined time to initialize the latch circuit 502. Therefore, when the secondary battery 201 is connected with the battery state monitoring circuit 102, the discharge inhibiting signal is not outputted because the output signal 505 of the latch circuit 502 is always started from the Lo level indicating the normal state.

When the secondary battery 201 having the normal state voltage is connected with the battery state monitoring circuit 102 in a battery device assembly process in the factory, the power source voltage of the battery state monitoring circuit 102 reaches a voltage range of the normal state through a voltage range of the over-discharge state during the predetermined time for which the power-down protection circuit 109 operates, so the battery state monitoring circuit 102 does not output the discharge inhibiting signal. As a result, the FET-A 303 is not turned off and the supply of the power source voltage from the secondary battery 201 to the external terminal 205 is not stopped, so the external terminal 205 is not pulled up to the potential of the external terminal 204. Therefore, the battery state monitoring circuit 102 can be prevented from entering the power-down state. Thus, the battery device of the present invention becomes the normal state in which it is chargeable and dischargeable after the lapse of a predetermined time.

On the other hand, when the secondary battery 201 having an over-discharge state voltage is connected with the battery state monitoring circuit 102 in the battery device assembly process in the factory, the power source voltage of the battery state monitoring circuit 102 is in the voltage range of the over-discharge state even after the lapse of the predetermined time for which the power-down protection circuit 109 operates, so the battery state monitoring circuit 102 outputs the discharge inhibiting signal. As a result, the FET-A 303 is turned off and the supply of the power source voltage from the secondary battery 201 to the external terminal 205 is stopped, so the external terminal 205 is pulled up to the potential of the external terminal 204. Therefore, the battery state monitoring circuit 102 enters the power-down state.

### Embodiment 2

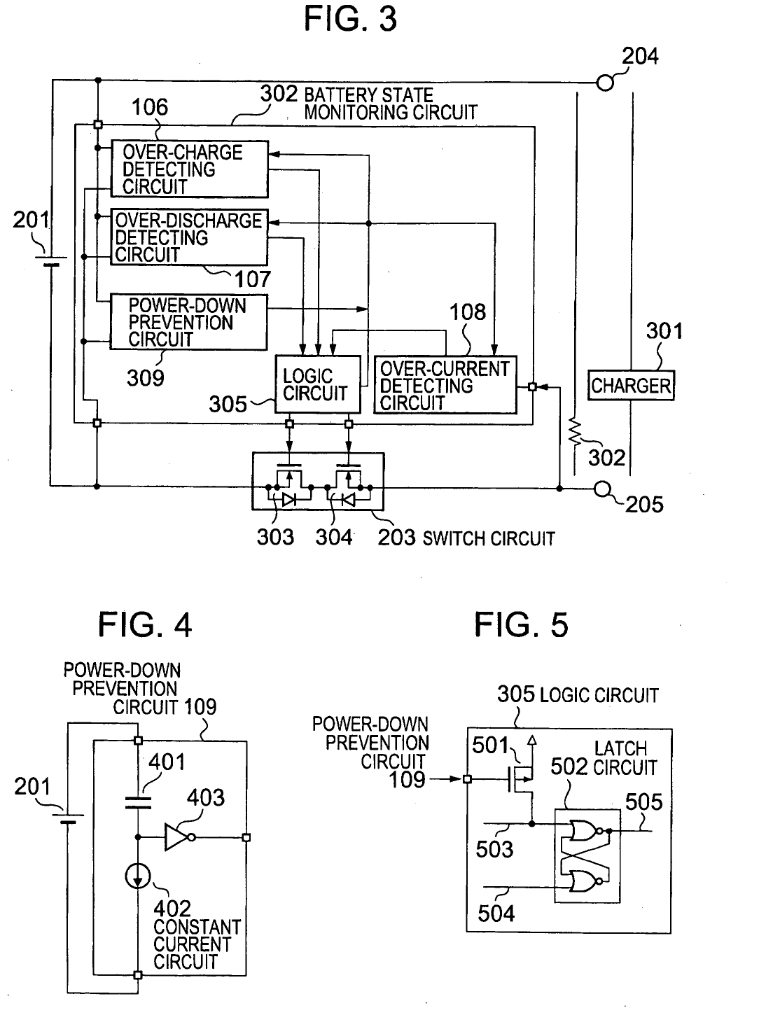

FIG. 3 is a circuit block diagram showing a battery state monitoring circuit and a battery device according to Embodiment 2 of the present invention. In FIG. 3, instead of the power-down protection circuit 109, a power-down protection circuit 309 is provided to compose a battery state monitoring circuit 302. Other circuits are identical to those shown in FIG. 1.

The same structure as that of the power-down protection circuit 109 can be used for the power-down protection circuit 309. The power-down protection circuit 309 monitors the power source voltage of the battery state monitoring circuit 302. The power-down protection circuit 309 outputs a detection signal only for a predetermined time when it detects a transient increase in voltage which is caused at the time of turning on the power. Therefore, the operation for entering the power-down state is stopped only for the predetermined time.

In the power down state, the current consumption is reduced. More specifically, the operation of the monitoring circuit for monitoring the battery state such as the over-charge state, the over-discharge state, or the over-current state is stopped in accordance with a power-down signal to suppress the current consumption. When the power-down signal is masked during only for a predetermined time period from the time of turning on the power to prevent the monitoring circuit from stopping, the power source voltage of the battery state monitoring circuit 302 increases up to the normal state level through the over-discharge range during the predetermined time. Therefore, the discharge inhibiting signal which is transiently being outputted is also released during the predetermined time, with the result that the battery device can enter the normal state in which it is chargeable and dischargeable. Thus, it is possible to obtain the same effect as that shown in FIG. 1 in which the logic circuit 305 is disabled from outputting the discharge inhibiting signal only for the predetermined time.

Therefore, according to the battery state monitoring circuit and the battery device in the present invention, the problems related to the conventional battery device that enters the power-down state in assembly are solved. Thus, in the case of the secondary battery which is in the normal state, the external load can be instantly driven immediately after assembly.

### DESCRIPTION OF SYMBOLS

202, 302 battery state monitoring circuit
106 over-charge detecting circuit
107 over-discharge detecting ci, mrcuit
108 over-current detecting circuit
109, 309 power-down prevention circuit
203 switch circuit
301 charger
305 logic circuit
402 constant current circuit
502 latch circuit

1. A battery state monitoring circuit which can control current limiting means for adjusting a current of a secondary battery that is chargeable and dischargeable and monitor at least one of a voltage and current of the secondary battery, the battery state monitoring circuit comprising:
an over-discharge detection circuit that outputs a detection signal for inhibiting discharging to the current limiting means when the voltage of the secondary battery is smaller than a lower limit of a dischargeable voltage thereof;
a power-down circuit that outputs a detection signal for reducing power consumption to the over-discharge detection circuit after the over-discharge detection circuit operates; and
a power-down protection circuit that disables the over-discharge detection circuit from outputting the detection signal for inhibiting discharging for a predetermined time period from a time of turning on power.

2. A battery state monitoring circuit which can control current limiting means for adjusting a current of a secondary battery that is chargeable and dischargeable and monitor at least one of a voltage and current of the secondary battery, the battery state monitoring circuit comprising:
an over-discharge detection circuit that outputs a detection signal for inhibiting discharging to the current limiting means when the voltage of the secondary battery is smaller than a lower limit of a dischargeable voltage thereof;
a power-down circuit that outputs a detection signal for reducing power consumption to the over-discharge detection circuit after the over-discharge detection circuit operates; and
a power-down protection circuit that disables the power-down circuit from outputting the detection signal for reducing the power consumption for a predetermined time period from a time of turning on power.

3. A battery device, comprising:
a secondary battery which is chargeable and dischargeable and connected between a positive terminal and a negative terminal, each of which is an external terminal;
current limiting means for adjusting a current of the secondary battery, which is connected between the positive terminal and the negative terminal; and
a battery state monitoring circuit that can control the current limiting means and monitor at least one of a voltage and current of the secondary battery,
wherein the battery state monitoring circuit comprises the battery state monitoring circuit according to claim 1.

4. A battery device, comprising:
a secondary battery which is chargeable and dischargeable and connected between a positive terminal and a negative terminal, each of which is an external terminal;
current limiting means for adjusting a current of the secondary battery, which is connected between the positive terminal and the negative terminal; and
a battery state monitoring circuit that can control the current limiting means and monitor at least one of a voltage and current of the secondary battery,
wherein the battery state monitoring circuit comprises the battery state monitoring circuit according to claim 2.
